(19) United States
(12) Patent Application Publication
(10) Pub. No.: US 2017/0056994 A1
(43) Pub. Date: Mar. 2, 2017

(54) LIQUID PHASE BONDING OF A SILICON OR SILICON CARBIDE COMPONENT TO ANOTHER SILICON OR SILICON CARBIDE COMPONENT

(71) Applicant: LAM RESEARCH CORPORATION, Fremont, CA (US)

(72) Inventors: Steven M. Joslin, Liberty Township, OH (US); Peter Langan, Liberty Township, OH (US); Vijay Nithiananthan, Eaton, OH (US); Jihong Chen, Cincinnati, OH (US)

(21) Appl. No.: 14/839,344

(22) Filed: Aug. 28, 2015

(51) Int. Cl. B23K 1/00; B23K 1/008; C22C 21/02; B23K 1/19; B23K 35/28; B23K 35/24; B23K 1/005; B23K 1/06

(52) U.S. Cl. CPC B23K 1/0016; B23K 1/0004; B23K 1/0053; B23K 1/008; B23K 1/06; B23K 1/19; B23K 35/286; B23K 35/24; C22C 21/02

(57) ABSTRACT

A method for creating and using an assembly includes arranging a bonding material between a first component and a second component. The first component, the bonding material and the second component are heated to a predetermined temperature for a predetermined period to melt the bonding material and to create an assembly. The predetermined temperature is at or greater than a melting temperature of the bonding material and less than a melting temperature of the first component and the second component. The method includes using the assembly inside a batch furnace of a substrate processing system or a processing chamber of a substrate processing system. The first component and the second component are made from a material selected from a group consisting of silicon and silicon carbide. The bonding material is selected from a group consisting of aluminum, gold, germanium, indium or an alloy of silicon and aluminum, gold, germanium, or indium.

### FIELD

The present disclosure relates to liquid phase bonding of components, and more particularly to liquid phase bonding of a silicon or silicon carbide component to another silicon or silicon carbide component using a bonding material to create an assembly.

### BACKGROUND

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Semiconductor processing systems may include components that need to be made of silicon (Si) and/or silicon carbide (SiC). Large components that are made using Si and/or SiC are expensive to manufacture. The cost to produce starting blanks for manufacturing these large components increases with finished part dimensions. The starting blanks are typically made from single crystal, dislocation free (DF) Si or SiC ingots that are sliced to a required thickness.

In many cases, the machining process is time consuming and has high labor cost. Some components may require large amounts of material to be removed from the starting blank, which is costly and time consuming. Some components (such as a gas distribution plate with an internal plenum) are impossible to make using a monolithic Si or SiC blank. Core drilling and electrical discharge machining (EDM) are effective approaches for reducing material loss and machining time for certain types of components such as ring-shaped components. Larger and more complex components can be assembled using two or more smaller and simpler components that are machined separately and then bonded together. This approach can significantly lower manufacturing costs as compared to machining the equivalent part from a single, monolithic blank.

Elastomers have been used to bond silicon to silicon, silicon to graphite, and silicon to aluminum. However, the elastomer bond has relatively weak tensile strength (typically about ˜470 psi). The use of elastomer also limits the working temperature to about 185° C. The elastomer bond typically has higher resistivity and lower thermal conductivity than bulk silicon. The elastomer bond is also prone to generate particle contamination in substrate processing systems.

### SUMMARY

A method for creating and using an assembly includes arranging a bonding material between and in contact with a first component and a second component. The method further includes heating the first component, the bonding material and the second component to a predetermined temperature for a predetermined period to melt the bonding material and to create an assembly. The predetermined temperature is greater than or equal to a melting temperature of the bonding material and less than a melting temperature of the first component and the second component. The method includes using the assembly inside a batch furnace of a substrate processing system or a processing chamber of a substrate processing system. The first component and the second component are made from a material selected from a group consisting of silicon and silicon carbide. The bonding material is selected from a group consisting of aluminum, gold, germanium, indium, an alloy of silicon and aluminum, an alloy of silicon and gold, an alloy of silicon and germanium, and an alloy of silicon and indium.

In other features, the method includes operating the furnace at vacuum pressure. The bonding material includes aluminum having a purity greater than or equal to 99%. The bonding material includes gold having a purity greater than or equal to 99%. The bonding material includes indium having a purity greater than or equal to 99%. The bonding material includes germanium having a purity greater than or equal to 99%. The first component includes silicon and the second component includes silicon. The first component includes silicon and the second component includes silicon carbide. The first component includes silicon carbide and the second component includes silicon carbide.

In other features, the predetermined period is in a range from 15 minutes to 4 hours. The bonding material includes an alloy of silicon and wherein the alloy has eutectic composition. The bonding material includes an alloy of silicon and wherein the alloy does not have eutectic composition.

In other features, the heating the first component, the bonding material and the second component is performed in a furnace. The heating of the first component, the bonding material and the second component is performed using direct current. The heating of the first component, the bonding material and the second component is performed using alternating current. The heating of the first component, the bonding material and the second component is performed using radio frequency power. The heating of the first component, the bonding material and the second component is performed using infrared frequency radiation.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 illustrates a bonding material arranged between two or more components according to the present disclosure;

FIG. 2 illustrates the two or more components bonded together by the bonding material to create an assembly for use in a substrate processing system according to the present disclosure;

FIG. 3 is a flowchart illustrating an example of a method for liquid phase bonding according to the present disclosure;

FIG. 4 illustrates an example of a furnace that may be used to heat the two or more components and the bonding material to create the assembly according to the present disclosure; and

FIG. 5 is a functional block diagram of an example of a control system for controlling the furnace according to the present disclosure.

In the drawings, reference numbers may be reused to identify similar and/or identical elements.

### DETAILED DESCRIPTION

Systems and methods according to the present disclosure provide the ability to assemble two or more Si and/or SiC components using bonding materials that create a liquid phase at substantially lower temperatures than the melting point of the materials used for the two or more components. The ability to assemble parts from separate components can significantly lower manufacturing costs as compared to machining an equivalent part from a single, monolithic blank.

In some examples, selected portions of a part that was typically made entirely of Si and/or SiC can be made from a combination of Si and SiC. The parts that are described herein may be used in batch furnaces used for substrate processing, in processing chambers of deposition tools, etch tools or other tools used for substrate processing or for other uses.

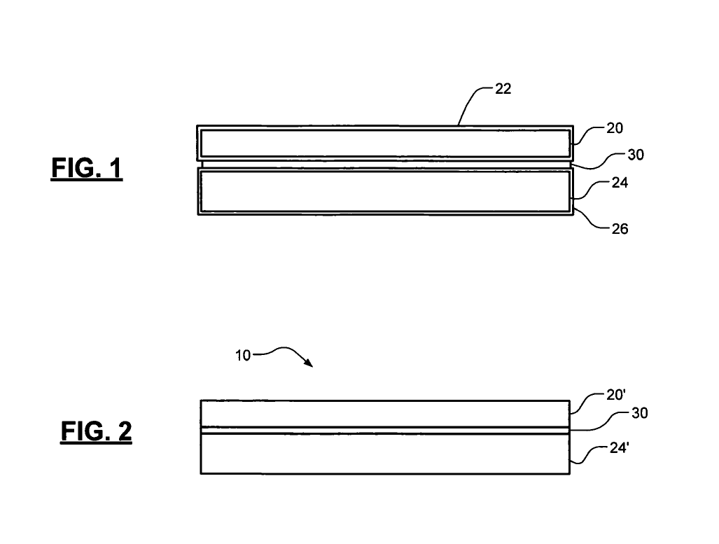

Referring now to FIGS. 1 and 2, first and second components 20, 24 are bonded together to create an assembly that is used inside a substrate processing system. The first and second components 20, 24 may have a native oxide layer 22, 26, respectively, that may be removed by annealing during the bonding process. For example, the native oxide layer such (as SiO₂) decomposes when heated to ˜600° C. in vacuum and is pumped away. While two components are shown, two or more components may be bonded at the same time.

A bonding material 30 is arranged between the first and second components 20, 24 that are to be bonded together. The bonding material 30 has a melting temperature that is substantially lower than the melting point of the first and second components 20, 24. The first and second components 20, 24 and the bonding material 30 are heated in a furnace to a temperature that is at or above a melting temperature of the bonding material 30 and lower than the melting temperature of the first and second materials 20, 24. The bonding materials solidification point can be tuned by the temperature and its duration.

The native oxide layers 22, 26 on the first and second components 20, 24 are annealed in the furnace, which volatilizes the native oxide layers. The temperature of the furnace is selected to be sufficient to form a liquid phase of the bonding material 30 but not a liquid phase of the first and second components 20, 24. Subsequently, the assembly is allowed to cool to solidify the bonding material 30. In FIG. 2, the assembly 10 is shown after the components are bonded together and cooled.

In some examples, the first and second components 20, 24 include silicon (Si) and/or silicon carbide (SiC). In some examples, the bonding material 30 includes aluminum (Al), gold (Au), germanium (Ge), or indium (In). In some examples, the Al, Au Ge, or In has a purity that is greater than 99%. In other examples, the Al, Au, Ge or In has a purity that is greater than 99.9%. In some examples, the remaining 1% or 0.1% of the Al, Au, Ge or In bonding material does not include Si or SiC.

In still other examples, the bonding material 30 includes silicon alloy such as Al—Si, Au—Si, Ge—Si, or In—Si. In some examples, the Al—Si alloy includes 87.5% Al and 12.5% Si. In some examples, the Al—Si alloy includes less than or equal to 12.5% Si. In some examples, the Au—Si alloy includes 97.15% Au and 2.85% Si. In some examples, the Au—Si alloy includes less than or equal to 2.85% Si. In some examples, the In—Si alloy includes less than or equal to 20% Si.

The melting temperature of Al, Au and In are 660° C., 1064° C. and 157° C., respectively. The melting temperature of Si and SiC are 1414° C. and 2730° C. at high pressures, respectively. The alloys may or may not form eutectic compositions with Si. If Al or Si—Al alloys are used as the bonding material 30, a low oxygen ambient may be used. The low oxygen ambient may be achieved using vacuum and/or inert gas with the furnace or processing chamber.

In some examples, the bonding material and first and second components are selected based on the applications of the bonded parts. For example, SiC component is placed in highly corrosive area and Si in the less corrosive area to the working lifetime of a bonded SiC/Si part.

In some examples, the components and the bonding material are heated in the furnace for a period that is in the range of 15 minutes to 4 hours. In other examples, the components and the bonding material are heated in the furnace for a period that is in the range of 30 minutes to 2 hours. In other examples, the components and the bonding material are heated in the furnace for a period that is in the range of 45 minutes to 90 minutes.

In other examples, the components and the bonding material are heated using an alternate heat source such as direct current (DC), alternating current (AC) radio frequency power or infrared radiation.

In one example, the bonding material 30 includes 99% pure aluminum foil having a thickness of 0.001 inch. The bonding material 30 is arranged between two or more components made of Si. The assembly including the bonding material and the two or more components that are made of Si are arranged in a furnace having a pressure of 0.01 mbar and a temperature of 800° C. for a period of one hour.

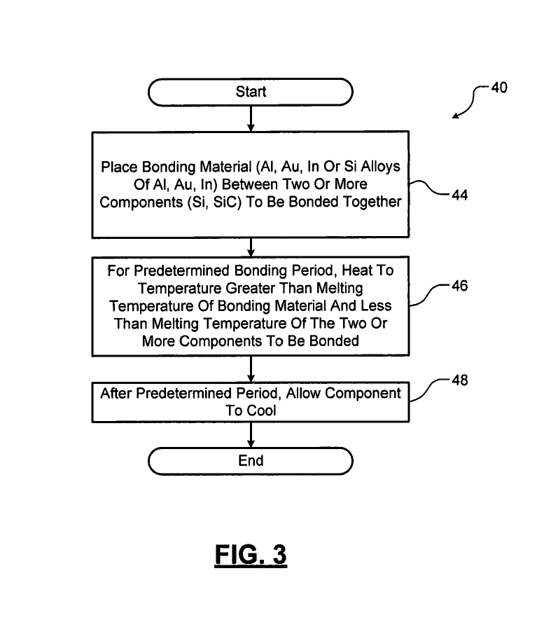

Referring now to FIG. 3, a method 44 for liquid phase bonding two or more components together using a bonding material to make an assembly is shown. At 44, a bonding material is arranged between the two or more components to be bonded together. The two or more components and the bonding material are made of materials described above. At 46, heat is applied to raise a temperature of a stack including the two or more components and the bonding material. The heat is applied for a predetermined period to increase a temperature of the stack to a temperature that is at or greater than a melting temperature of the bonding material and less than the melting temperature of the two or more components to be bonded together. At 48, the two or more components are allowed to cool to solidify the bonding material.

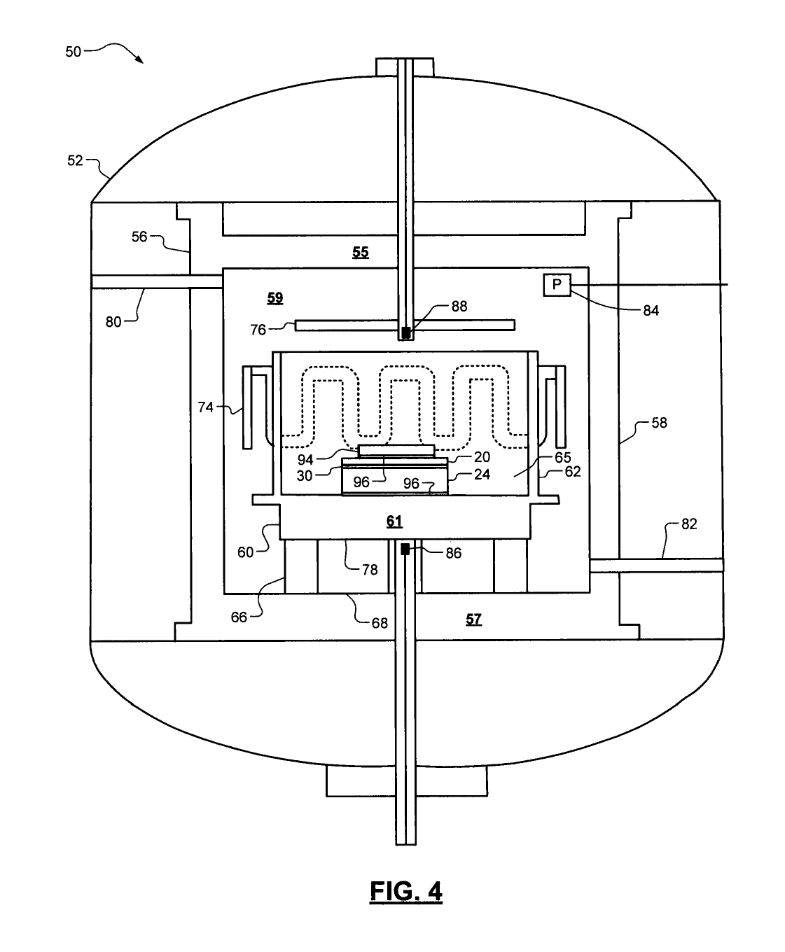

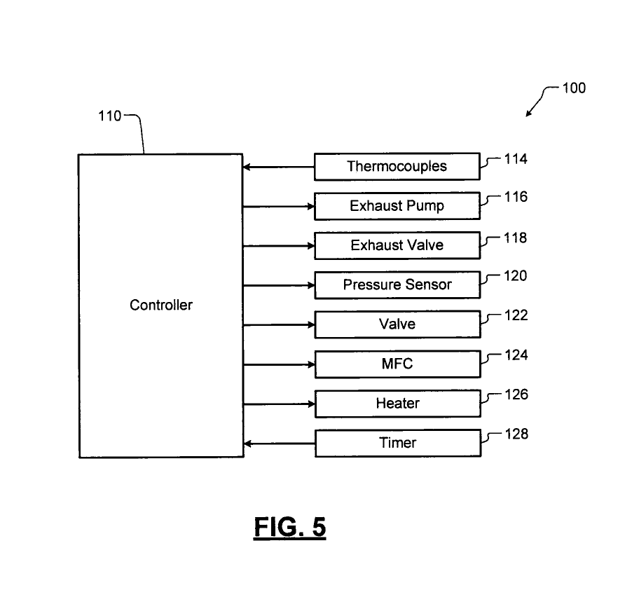

Referring now to FIG. 4, an example of a furnace that is suitable for liquid phase bonding the two or more components together is shown. While a stationary furnace is shown, a conveyor-type furnace can also be used. A bonding apparatus 50 is shown to include a housing 52. A thermal insulating structure 56 is arranged inside of the housing 52. The thermal insulating structure 56 includes a bottom portion 57 and one or more side walls 58 that define an inner cavity 59. A top portion 55 or bottom portion 57 may be removable and/or include an opening (not shown) for loading and unloading bonding assembly.

A susceptor 60 is arranged in the inner cavity 59 of the thermal insulating structure 56. The susceptor 60 includes a bottom portion 61 and one or more side walls 62 that define an inner cavity 65 to receive parts to be bonded. In some examples, the susceptor 60 is made of graphite and has a cylindrical or cubicle cross-section, although other materials and/or cross-sections may be used. One or more supports 66 may be attached to or extend from the susceptor 60 to a bottom surface 68 of the inner cavity 59 of the thermal insulating structure 56. The supports 66 locate the susceptor 60 in a position that is spaced from the bottom surface 68.

One or more heaters 74 may be arranged around an outer periphery of the side walls 62 of the susceptor 60. The heater 74 may be spaced by a predetermined gap from the susceptor 60. Likewise, a heater 76 may be arranged a predetermined distance above a top surface of the susceptor 60. Additional heaters (not shown) may be arranged adjacent to the bottom surface 78 of the susceptor 60. In some examples, the heaters 74 and 76 may have linear, spiral, coiled, or “S”-shaped configurations, although other configurations may be used.

Gas may be supplied to the inner cavity 59 of the thermal insulating structure 56 by a gas inlet 80. Gas and other reactants may be evacuated from the inner cavity 59 of the thermal insulating structure 56 by a gas outlet 82. In some examples, an inert gas such argon (Ar), helium (He) or molecular nitrogen (N₂) may be supplied to the inner cavity 59 of the thermal insulating structure 56 during the bonding process. A pressure sensor 84 may be arranged in the inner cavity 59 to measure pressure in the cavity 59. Thermocouples 86 and 88 may be used to sense one or more temperatures in the inner cavity 59 of the thermal insulating structure 56.

In use, the first and second components 20, 24 and the bonding material 30 are placed in the inner cavity 65 of the susceptor 60. In some examples, a press 94 such as a weight may be used to supply external force to hold the parts together. In other examples, the weight of one of the parts may be used to hold the parts together. In some examples, an external force of 0.01 MPa-10 Mpa may be used for bonding using either the press 94 or the weight of one or more of the parts to be bonded.

In some examples, a carbon material 96 is used between the silicon parts and external fixtures such as the susceptor 60 and/or the press 94. In some examples, the carbon material 96 includes graphite or grafoil, although other materials may be used.

Referring now to FIG. 5, a control system 100 may be used to control operation of the bonding apparatus 50 during bonding of parts. The control system 100 includes a controller 110 that communicates with thermocouples 114 (such as thermocouples 86 and 88) to monitor temperatures within the cavity 59. The controller 110 may also communicate with an exhaust pump 116 and an exhaust valve 118 to create vacuum pressure and/or to evacuate the cavity 59.

The controller 110 may communicate with a pressure sensor 120 to control pressure inside of the cavity 59. Inert gas may be supplied to the cavity 59 of the thermal insulating structure 56 using one or more valves 122 and one or more mass flow controllers (MFCs) 124. The controller 110 may communicate with one or more heaters 126 (such as the heaters in FIG. 4) to control the temperature in the bonding apparatus 50 during bonding. The controller 110 may communicate with an internal timer (not shown) or an external timer 128 to determine the predetermined bonding period.

Systems and methods according to the present disclosure allow parts or assemblies having complex shapes to be assembled and bonded rather than machined from a single large piece of silicon or silicon carbide. A relatively narrow bond width limits exposure of aluminum to the reactive environment. Preliminary estimates suggest sufficient mechanical strength for various intended applications in furnaces and/or processing chambers used for substrate processing.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

What is claimed is:

1. A method for creating and using an assembly, the method comprising:
arranging a bonding material between and in contact with a first component and a second component;
heating the first component, the bonding material and the second component to a predetermined temperature for a predetermined period to melt the bonding material and to create an assembly,
wherein the predetermined temperature is greater than or equal to a melting temperature of the bonding material and less than a melting temperature of the first component and the second component; and
using the assembly inside a batch furnace of a substrate processing system or a processing chamber of a substrate processing system,
wherein the first component and the second component are made from a material selected from a group consisting of silicon and silicon carbide, and
wherein the bonding material is selected from a group consisting of aluminum, gold, indium, germanium, an alloy of silicon and aluminum, an alloy of silicon and gold, an alloy of silicon and germanium, and an alloy of silicon and indium.

2. The method of claim 1, further comprising operating the furnace at vacuum pressure.

3. The method of claim 1, wherein the bonding material includes aluminum having a purity greater than or equal to 99%.

4. The method of claim 1, wherein the bonding material includes gold having a purity greater than or equal to 99%.

5. The method of claim 1, wherein the bonding material includes indium having a purity greater than or equal to 99%.

6. The method of claim 1, wherein the bonding material includes germanium having a purity greater than or equal to 99%.

7. The method of claim 1, wherein the first component includes silicon and the second component includes silicon.

8. The method of claim 1, wherein the first component includes silicon and the second component includes silicon carbide.

9. The method of claim 1, wherein the first component includes silicon carbide and the second component includes silicon carbide.

10. The method of claim 1, wherein the predetermined period is in a range from 15 minutes to 4 hours.

11. The method of claim 1, wherein the bonding material includes an alloy of silicon and wherein the alloy has eutectic composition.

12. The method of claim 1, wherein the bonding material includes an alloy of silicon and wherein the alloy does not have eutectic composition.

13. The method of claim 1, wherein the heating the first component, the bonding material and the second component is performed in a furnace.

14. The method of claim 1, wherein the heating the first component, the bonding material and the second component is performed using direct current.

15. The method of claim 1, wherein the heating the first component, the bonding material and the second component is performed using alternating current.

16. The method of claim 1, wherein the heating the first component, the bonding material and the second component is performed using radio frequency power.

17. The method of claim 1, wherein the heating the first component, the bonding material and the second component is performed using infrared frequency radiation.
